(19) United States
(12) Patent Application Publication
(10) Pub. No.: US 2024/0370621 A1
(43) Pub. Date: Nov. 7, 2024

(54) PATTERN SELECTION SYSTEMS AND METHODS

(71) Applicant: ASML NETHERLANDS B.V., Veldhoven (NL)

(72) Inventors: Meng LIU, Shenzhen (CN); Been-Der CHEN, Milpitas, CA (US); Debao SHAO, Shenzhen (CN); Jen-Yi WUU, Sunnyvale, CA (US); Hao CHEN, Shenzhen (CN); Ayman HAMOUDA, Milpitas, CA (US); Jianhua CHENG, San Jose, CA (US)

(73) Assignee: ASML NETHERLANDS B.V., Veldhoven (NL)

(21) Appl. No.: 18/686,994

(22) PCT Filed: Aug. 22, 2022
(86) PCT No.: PCT/EP2022/073313

§ 371 Date: Feb. 27, 2024

(30) Foreign Application Priority Data
Sep. 22, 2021 (WO) PCT/CN2021/119631

(51) Int. Cl. G06F 30/392; G06F 111/20

(52) U.S. Cl. CPC G06F 30/392; G06F 2111/20

(57) ABSTRACT

Selecting an optimized, geometrically diverse subset of clips for a design layout for a semiconductor wafer is described. A complete representation of the design layout is received. A set of representative clips of the design layout is determined such that individual representative clips comprise different combinations of one or more unique patterns of the design layout. A subset of the representative clips is selected based on the one or more unique patterns. The subset of the representative clips is configured to include: (1) each geometrically unique pattern in a minimum number of representative clips; or (2) as many geometrically unique patterns of the design layout as possible in a maximum number of representative clips. The subset of representative clips is provided as training data for training an optical proximity correction or source mask optimization semiconductor process machine learning model, for example.

### CROSS-REFERENCE TO RELATED APPLICATIONS

This application claims priority of International application PCT/CN2021/119631 which was filed on Sep. 22, 2021 and which is incorporated herein in its entirety by reference.

### TECHNICAL FIELD

The present disclosure relates generally to pattern selection associated with computational lithography.

### BACKGROUND

A lithographic projection apparatus can be used, for example, in the manufacture of integrated circuits (ICs). A patterning device (e.g., a mask) may include or provide a pattern corresponding to an individual layer of the IC (“design layout”), and this pattern can be transferred onto a target portion (e.g. comprising one or more dies) on a substrate (e.g., silicon wafer) that has been coated with a layer of radiation-sensitive material (“resist”), by methods such as irradiating the target portion through the pattern on the patterning device. In general, a single substrate contains a plurality of adjacent target portions to which the pattern is transferred successively by the lithographic projection apparatus, one target portion at a time. In one type of lithographic projection apparatus, the pattern on the entire patterning device is transferred onto one target portion in one operation. Such an apparatus is commonly referred to as a stepper. In an alternative apparatus, commonly referred to as a step-and-scan apparatus, a projection beam scans over the patterning device in a given reference direction (the “scanning” direction) while synchronously moving the substrate parallel or anti-parallel to this reference direction. Different portions of the pattern on the patterning device are transferred to one target portion progressively. Since, in general, the lithographic projection apparatus will have a reduction ratio M (e.g., 4), the speed F at which the substrate is moved will be 1/M times that at which the projection beam scans the patterning device. More information with regard to lithographic devices can be found in, for example, U.S. Pat. No. 6,046,792, incorporated herein by reference.

Prior to transferring the pattern from the patterning device to the substrate, the substrate may undergo various procedures, such as priming, resist coating and a soft bake. After exposure, the substrate may be subjected to other procedures (“post-exposure procedures”), such as a post-exposure bake (PEB), development, a hard bake and measurement/inspection of the transferred pattern. This array of procedures is used as a basis to make an individual layer of a device, e.g., an IC. The substrate may then undergo various processes such as etching, ion-implantation (doping), metallization, oxidation, chemo-mechanical polishing, etc., all intended to finish the individual layer of the device. If several layers are required in the device, then the whole procedure, or a variant thereof, is repeated for each layer. Eventually, a device will be present in each target portion on the substrate. These devices are then separated from one another by a technique such as dicing or sawing, such that the individual devices can be mounted on a carrier, connected to pins, etc.

Manufacturing devices, such as semiconductor devices, typically involves processing a substrate (e.g., a semiconductor wafer) using a number of fabrication processes to form various features and multiple layers of the devices. Such layers and features are typically manufactured and processed using, e.g., deposition, lithography, etch, chemical-mechanical polishing, and ion implantation. Multiple devices may be fabricated on a plurality of dies on a substrate and then separated into individual devices. This device manufacturing process may be considered a patterning process. A patterning process involves a patterning step, such as optical and/or nanoimprint lithography using a patterning device in a lithographic apparatus, to transfer a pattern on the patterning device to a substrate and typically, but optionally, involves one or more related pattern processing steps, such as resist development by a development apparatus, baking of the substrate using a bake tool, etching using the pattern using an etch apparatus, etc.

Lithography is a central step in the manufacturing of device such as ICs, where patterns formed on substrates define functional elements of the devices, such as microprocessors, memory chips, etc. Similar lithographic techniques are also used in the formation of flat panel displays, micro-electro mechanical systems (MEMS) and other devices.

As semiconductor manufacturing processes continue to advance, the dimensions of functional elements have continually been reduced. At the same time, the number of functional elements, such as transistors, per device has been steadily increasing, following a trend commonly referred to as “Moore's law.” At the current state of technology, layers of devices are manufactured using lithographic projection apparatuses that project a design layout onto a substrate using illumination from a deep-ultraviolet illumination source, creating individual functional elements having dimensions well below 100 nm, i.e. less than half the wavelength of the radiation from the illumination source (e.g., a 193 nm illumination source).

This process in which features with dimensions smaller than the classical resolution limit of a lithographic projection apparatus are printed, is commonly known as low-kl lithography, according to the resolution formula CD=k1×λ/NA, where 2 is the wavelength of radiation employed (currently in most cases 248 nm or 193 nm), NA is the numerical aperture of projection optics in the lithographic projection apparatus, CD is the “critical dimension”-generally the smallest feature size printed-and kl is an empirical resolution factor. In general, the smaller kl the more difficult it becomes to reproduce a pattern on the substrate that resembles the shape and dimensions planned by a designer in order to achieve particular electrical functionality and performance. To overcome these difficulties, sophisticated fine-tuning steps are applied to the lithographic projection apparatus, the design layout, or the patterning device. These include, for example, but not limited to, optimization of NA and optical coherence settings, customized illumination schemes, use of phase shifting patterning devices, optical proximity correction (OPC, sometimes also referred to as “optical and process correction”) in the design layout. source mask optimization (SMO). or other methods generally defined as “resolution enhancement techniques” (RET).

### SUMMARY

Tools exist to identify geometrically unique portions of a pattern layout (e.g., unique clips or patches from a full chip IC design layout), each portion having a certain area of patterns. The identified unique portions are different from each other. However, the number of unique portions determined by these tools is very large, and there is no effective mechanism to cap or otherwise control this number. Often, some of the unique portions (e.g., clips or patches) that are reported have geometry that is only slightly different, and include a large amount of redundant information from one portion to the next. The large number of unique portions determined, and the redundant information, can burden downstream computing (e.g., computational lithography) processes because the large number and/or redundant information creates a need for significant computing resources.

According to embodiments of the present disclosure, systems and methods are configured for selecting an optimized, geometrically diverse subset of unique portions (e.g., clips or patches) that have a reduced number of portion counts, and yet in combination, encompass adequate patterns from the pattern layout (e.g. a design layout). The number of the selected unique portions may be up to 100 times less than the large number of portions identified by prior tools, for example. Even though significantly fewer unique portions are selected, they include enough geometric diversity, e.g., to represent the whole pattern layout of a full chip. This can significantly reduce required computing resources, and expedite downstream computing processes, among other advantages.

Thus, according to an embodiment, there is provided a method for selecting an optimized, geometrically diverse set of portions (e.g., clips or patches) for a pattern (e.g., design) layout for a semiconductor wafer. The method comprises receiving a representation (e.g., an original and/or complete representation) of the pattern layout. The method comprises determining a set of representative portions of the pattern layout, where individual representative portions comprise different combinations of one or more (e.g., geometrically) unique patterns of the pattern layout.

As used herein, “unique pattern” refers to a pattern that is deemed different than other unique patterns in the pattern layout (design layout). A pattern is usually defined by a spatial window of interest in the layout. Pattern uniqueness can be defined by having a specific unique representation in a representation space. For example, uniqueness may be defined by having a specific unique shape(s), arrangement(s) of features, contour(s), etc., in a representation in a spatial window of interest. A unique pattern may have many instances (e.g., may repeat) across the pattern layout. A unique pattern may include identical or similar instances. Unique patterns may be extracted or identified from a pattern layout by using exact matching, fuzzy matching, clustering, or other algorithms or methods. Thus, as referred herein, a unique pattern may be a pattern representative of a group of patterns that exactly match, or a group of patterns that are similar, as can be identified by fuzzy matching.

A set of representative portions (e.g., clips or patches) may be determined by grouping patterns that repeat across the pattern layout. A subset of the representative portions may then be selected based on the one or more unique patterns. The subset of the representative portions is selected such that it includes the unique patterns in a significantly reduced number of representative portions (relative to the set of representative portions). In some embodiments, the selected subset of representative portions contains an optimally diverse group of unique patterns and has a less than a prescribed limit number of representative portions. The method may further comprise providing the selected subset of representative portions as training data for training a machine learning model. The machine learning model can be associated with optical proximity correction (OPC) and/or source mask optimization (SMO) for a semiconductor lithography process, for example.

In some embodiments, the representation of the pattern layout comprises a Graphic Design System (.GDS) file.

In some embodiments, the selecting of the subset of the representative portions (e.g., clips or patches) is performed by using a set cover solver method. In some embodiments, this comprises determining the subset of the representative portions with a discrete optimizer (e.g. an integer linear programming solver) to determine the subset of the representative portions. In some embodiments, the subset of the representative portions is optimized to include a maximum amount of unique geometry from the pattern layout.

In some embodiments, the subset of the representative portions is selected such that the representative portions in the subset meet a certain quantity criterion, and the unique patterns encompassed in the subset also meet a certain diversity or quantity criterion. For example, given the processing power of a certain computing system or other factors, a certain maximum number of clips may be specified to use for modelling or other purposes, e.g., to ensure the computing system does not slow unreasonably and/or encounter other issues during modelling, etc. In some embodiments, a computing system may automatically limit itself to the predetermined (e.g., maximum) number of representative portions (e.g., clips). In some embodiments, systems and methods are configured to select a predetermined number of representative clips (the subset) that in combination encompass the most geometrically unique patterns of the pattern layout.

In some embodiments, the subset of the representative portions may be ranked based on a quantity and/or a rarity of the one or more unique patterns that each representative portion includes. The subset of the representative portions may be determined based on rank.

In some embodiments, the number of portions in the subset of the representative portions is less than the number of portions in the set of representative portions by a factor of about 10-100X.

According to another embodiment, there is provided a method for determining a subset of representative portions (e.g., clips or patches) of a pattern layout. The method comprises receiving a set of representative portions of the pattern layout. Individual representative portions comprise one or more unique patterns of the pattern layout. The selected subset of the representative portions comprises unique patterns that meet a prescribed criterion.

According to another embodiment, there is provided a system for determining a subset of representative portions of a pattern layout. The system comprises one or more hardware processors configured by machine readable instructions to perform a method stated above.

According to another embodiment, there is provided a non-transitory computer readable medium having instructions thereon, where the instructions, when executed by a computer, cause the computer to perform a method stated above.

### BRIEF DESCRIPTION OF THE DRAWINGS

The accompanying drawings, which are incorporated in and constitute a part of the specification, illustrate one or more embodiments and, together with the description, explain these embodiments. Embodiments of the invention will now be described, by way of example only, with reference to the accompanying schematic drawings in which corresponding reference symbols indicate corresponding parts, and in which:

FIG. 1 illustrates a block diagram of various subsystems of a lithographic projection apparatus.

FIG. 2 illustrates a flow chart of an exemplary method for simulating lithography in a lithographic projection apparatus, according to an embodiment.

FIG. 3 illustrates an exemplary method of selecting representative portions (e.g., clips or patches) of a pattern layout, according to an embodiment.

FIG. 4 illustrates an exemplary method of determining a set of representative portions of a pattern layout, according to an embodiment.

FIG. 5 illustrates an exemplary method of determining the set of representative portions based on grouped patterns, according to an embodiment.

FIG. 6 illustrates an exemplary method of selecting a subset of representative portions, according to an embodiment.

FIG. 7 is a block diagram of an example computer system, according to an embodiment.

FIG. 8 is a schematic diagram of a lithographic projection apparatus, according to an embodiment.

FIG. 9 is a schematic diagram of another lithographic projection apparatus, according to an embodiment.

FIG. 10 is a detailed view of a lithographic projection apparatus, according to an embodiment.

FIG. 11 is a detailed view of the source collector module of the lithographic projection apparatus, according to an embodiment.

### DETAILED DESCRIPTION

As described above, tools exist to identify geometrically unique portions of a pattern design or pattern layout (e.g., unique clips from a full chip IC design layout). However, the number of geometrically unique portions identified by these tools is very large, and the geometrically unique portions often include a large amount of redundant information from one portion to the next. This is because, even though a portion may be unique, it may only be slightly different than other portions, and still include a large number of unique patterns (e.g., combinations of shapes, contours, etc.) of the pattern layout that are also included in several other portions.

As described above, a “unique pattern” refers to a pattern that is deemed different than other unique patterns in the pattern layout (design layout). For example, uniqueness may be defined by having a specific unique shape(s), arrangement(s) of features, contour(s), etc., in a representation in a spatial window of interest. A unique pattern may have many instances (e.g., may repeat) across the pattern layout. A unique pattern may include identical or similar instances. Unique patterns may be extracted or identified from a pattern layout by using exact matching, fuzzy matching, clustering, or other algorithms or methods. Thus, as referred herein, a unique pattern may be a pattern representative of a group of patterns that exactly match, or a group of patterns that are similar, as can be identified by fuzzy matching.

According to embodiments of the present disclosure, an optimized, geometrically diverse subset of representative portions (e.g., clips or patches) of a pattern layout (e.g. a design layout) is selected such that the subset still comprehensively represents the pattern layout (e.g., the entire pattern layout) for subsequent modelling and/or other processes. For example, a selected subset of clips according to an embodiment of the present disclosure advantageously has a reduce number of clips, and yet can provide improved pattern coverage for the downstream model calibration or model training. Embodiments of the present disclosure use a discrete optimizer (e.g., integer linear programming solver) to identify an optimal subset of representative portions (instead of simply using all available portions) which include as much unique geometric information as possible. In this way, the present systems and methods can select a relatively small (compared to a full set) number of representative portions that include diverse geometric information. For example, the subset of the representative portions is selected such that it includes the unique patterns in a significantly reduced number of representative portions; or optimally diverse unique patterns in a predetermined number (e.g., maximum) of representative portions that form the selected subset of representative portions. This can significantly reduce required computing resources, and speed later computing processes, among other advantages.

Embodiments of the present disclosure are described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

Although specific reference may be made in this text to the manufacture of ICs, it should be explicitly understood that the description herein has many other possible applications. For example, it may be employed in the manufacture of integrated optical systems, guidance and detection patterns for magnetic domain memories, liquid-crystal display panels, thin-film magnetic heads, etc. The skilled artisan will appreciate that, in the context of such alternative applications, any use of the terms “reticle”, “wafer” or “die” in this text should be considered as interchangeable with the more general terms “mask”, “substrate” and “target portion”, respectively.

In the present document, the terms “radiation” and “beam” are used to encompass all types of electromagnetic radiation, including ultraviolet radiation (e.g. with a wavelength of 365, 248, 193, 157 or 126 nm) and EUV (extreme ultra-violet radiation, e.g. having a wavelength in the range of about 5-100 nm).

The term “projection optics,” as used herein, should be broadly interpreted as encompassing various types of optical systems, including refractive optics, reflective optics, apertures and catadioptric optics, for example. The term “projection optics” may also include components operating according to any of these design types for directing, shaping, or controlling the projection beam of radiation, collectively or singularly. The term “projection optics” may include any optical component in the lithographic projection apparatus, no matter where the optical component is located on an optical path of the lithographic projection apparatus. Projection optics may include optical components for shaping, adjusting and/or projecting radiation from the source before the radiation passes the (e.g., semiconductor) patterning device, and/or optical components for shaping, adjusting and/or projecting the radiation after the radiation passes the patterning device. The projection optics generally exclude the source and the patterning device.

A (e.g., semiconductor) patterning device can comprise, or can form, one or more patterns. The pattern can be generated utilizing CAD (computer-aided design) programs, based on a pattern or design layout, this process often being referred to as EDA (electronic design automation). Most CAD programs follow a set of predetermined design rules in order to create functional design layouts/patterning devices. These rules are set by processing and design limitations. For example, design rules define the space tolerance between devices (such as gates, capacitors, etc.) or interconnect lines, so as to ensure that the devices or lines do not interact with one another in an undesirable way. The design rules may include and/or specify specific parameters, limits on and/or ranges for parameters, and/or other information. One or more of the design rule limitations and/or parameters may be referred to as a “critical dimension” (CD). A critical dimension of a device can be defined as the smallest width of a line or hole or the smallest space between two lines or two holes, or other features. Thus, the CD determines the overall size and density of the designed device. One of the goals in device fabrication is to faithfully reproduce the original design intent on the substrate (via the patterning device).

The term “mask” or “patterning device” as employed in this text may be broadly interpreted as referring to a generic semiconductor patterning device that can be used to endow an incoming radiation beam with a patterned cross-section, corresponding to a pattern that is to be created in a target portion of the substrate; the term “light valve” can also be used in this context. Besides the classic mask (transmissive or reflective; binary, phase-shifting, hybrid, etc.), examples of other such patterning devices include a programmable mirror array and a programmable LCD array. An example of a programmable mirror array can be a matrix-addressable surface having a

viscoelastic control layer and a reflective surface. The basic principle behind such an apparatus is that (for example) addressed areas of the reflective surface reflect incident radiation as diffracted radiation, whereas unaddressed areas reflect incident radiation as undiffracted radiation. Using an appropriate filter, the said undiffracted radiation can be filtered out of the reflected beam, leaving only the diffracted radiation behind; in this manner, the beam becomes patterned according to the addressing pattern of the matrix-addressable surface. The required matrix addressing can be performed using suitable electronic means. An example of a programmable LCD array is given in U.S. Pat. No. 5,229,872, which is incorporated herein by reference.

As used herein, the term “patterning process” generally means a process that creates an etched substrate by the application of specified patterns of light as part of a lithography process. However, “patterning process” can also include (e.g., plasma) etching, as many of the features described herein can provide benefits to forming printed patterns using etch (e.g., plasma) processing.

As used herein, the term “pattern” means an idealized pattern that is to be etched on a substrate (e.g., wafer)—e.g., based on the design layout described above. A pattern may comprise, for example, various shape(s), arrangement(s) of features, contour(s), etc.

As used herein, a “printed pattern” means the physical pattern on a substrate that was etched based on a target pattern. The printed pattern can include, for example, troughs, channels, depressions, edges, or other two and three dimensional features resulting from a lithography process.

As used herein, the term “prediction model”, “process model”, “electronic model”, and/or “simulation model” (which may be used interchangeably) means a model that includes one or more models that simulate a patterning process. For example, a model can include an optical model (e.g., that models a lens system/projection system used to deliver light in a lithography process and may include modelling the final optical image of light that goes onto a photoresist), a resist model (e.g., that models physical effects of the resist, such as chemical effects due to the light), an OPC model (e.g., that can be used to make target patterns and may include sub-resolution resist features (SRAFs), etc.), an etch (or etch bias) model (e.g., that simulates the physical effects of an etching process on a printed wafer pattern), a source mask optimization (SMO) model, and/or other models.

As used herein, the term “calibrating” means to modify (e.g., improve or tune) and/or validate something, such as a model.

A patterning system may be a system comprising any or all of the components described above, plus other components configured to performing any or all of the operations associated with these components. A patterning system may include a lithographic projection apparatus, a scanner, systems configured to apply and/or remove resist, etching systems, and/or other systems, for example.

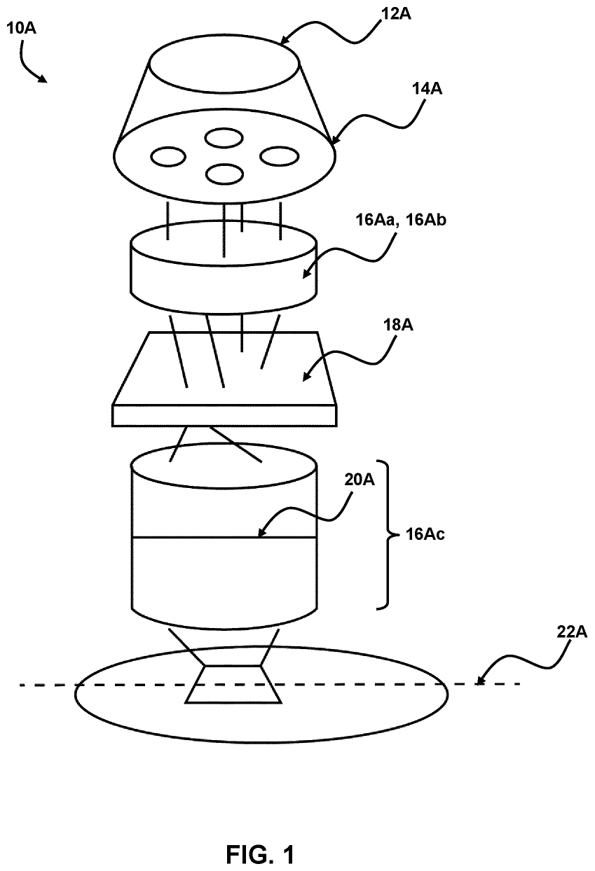

As an introduction, FIG. 1 illustrates a diagram of various subsystems of an example lithographic projection apparatus 10A. Major components are a radiation source 12A, which may be a deep-ultraviolet excimer laser source or other type of source including an extreme ultra violet (EUV) source (however, the lithographic projection apparatus itself need not have the radiation source), illumination optics which, for example, define the partial coherence (denoted as sigma) and which may include optics components 14A, 16Aa and 16Ab that shape radiation from the source 12A; a patterning device 18A; and transmission optics 16Ac that project an image of the patterning device pattern onto a substrate plane 22A. An adjustable filter or aperture 20A at the pupil plane of the projection optics may restrict the range of beam angles that impinge on the substrate plane 22A, where the largest possible angle defines the numerical aperture of the projection optics NA=n sin (Φₘₐₓ), wherein n is the refractive index of the media between the substrate and the last element of the projection optics, and Φₘₐₓ is the largest angle of the beam exiting from the projection optics that can still impinge on the substrate plane 22A.

In a lithographic projection apparatus, a source provides illumination (i.e. radiation) to a patterning device and projection optics direct and shape the illumination, via the patterning device, onto a substrate. The projection optics may include at least some of the components 14A, 16Aa, 16Ab and 16Ac. An aerial image (AI) is the radiation intensity distribution at substrate level. A resist model can be used to calculate the resist image from the aerial image, an example of which can be found in U.S. Patent Application Publication No. US 2009-0157630, the disclosure of which is hereby incorporated by reference in its entirety. The resist model is related to properties of the resist layer (e.g., effects of chemical processes which occur during exposure, post-exposure bake (PEB) and development). Optical properties of the lithographic projection apparatus (e.g., properties of the illumination, the patterning device, and the projection optics) dictate the aerial image and can be defined in an optical model. Since the patterning device used in the lithographic projection apparatus can be changed, it is desirable to separate the optical properties of the patterning device from the optical properties of the rest of the lithographic projection apparatus including at least the source and the projection optics. Details of techniques and models used to transform a design layout into various lithographic images (e.g., an aerial image, a resist image, etc.), apply OPC using those techniques and models and evaluate performance (e.g., in terms of process window) are described in U.S. Patent Application Publication Nos. US 2008-0301620, 2007-0050749, 2007-0031745, 2008-0309897, 2010-0162197, and 2010-0180251, the disclosure of each which is hereby incorporated by reference in its entirety.

It may be desirable to use one or more tools to produce results that, for example, can be used to design, control, monitor, etc. the patterning process. One or more tools used in computationally controlling, designing, etc. one or more aspects of the patterning process, such as the pattern design for a patterning device (including, for example, adding sub-resolution assist features or optical proximity corrections), the illumination for the patterning device, etc., may be provided. Accordingly, in a system for computationally controlling, designing, etc. a manufacturing process involving patterning, the manufacturing system components and/or processes can be described by various functional modules and/or models. In some embodiments, one or more electronic (e.g., mathematical, parameterized, machine learning, etc.) models may be provided that describe one or more steps and/or apparatuses of the patterning process. In some embodiments, a simulation of the patterning process can be performed using one or more electronic models to simulate how the patterning process forms a patterned substrate using a pattern provided by a patterning device.

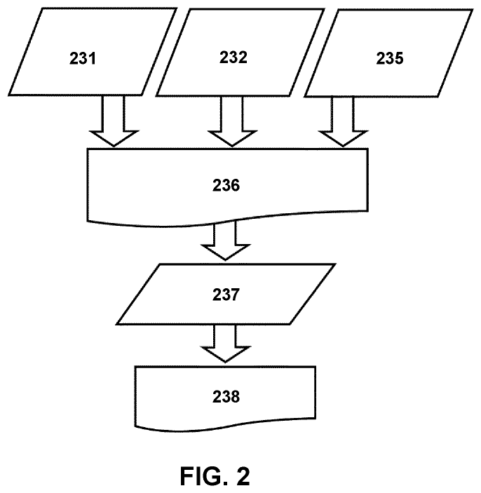

An exemplary flow chart for simulating lithography in a lithographic projection apparatus is illustrated in FIG. 2. An illumination model 231 represents optical characteristics (including radiation intensity distribution and/or phase distribution) of the illumination. A projection optics model 232 represents optical characteristics (including changes to the radiation intensity distribution and/or the phase distribution caused by the projection optics) of the projection optics. A design layout model 235 represents optical characteristics (including changes to the radiation intensity distribution and/or the phase distribution caused by a given design layout) of a design layout, which is the representation of an arrangement of features on or formed by a patterning device. An aerial image 236 can be simulated using the illumination model 231, the projection optics model 232, and the design layout model 235. A resist image 238 can be simulated from the aerial image 236 using a resist model 237. Simulation of lithography can, for example, predict contours and/or CDs in the resist image.

More specifically, illumination model 231 can represent the optical characteristics of the illumination that include, but are not limited to, NA-sigma (o) settings as well as any particular illumination shape (e.g. off-axis illumination such as annular, quadrupole, dipole, etc.). The projection optics model 232 can represent the optical characteristics of the of the projection optics, including, for example, aberration, distortion, a refractive index, a physical size or dimension, etc. The design layout model 235 can also represent one or more physical properties of a physical patterning device, as described, for example, in U.S. Pat. No. 7,587,704, which is incorporated by reference in its entirety. Optical properties associated with the lithographic projection apparatus (e.g., properties of the illumination, the patterning device, and the projection optics) dictate the aerial image. Since the patterning device used in the lithographic projection apparatus can be changed, it is desirable to separate the optical properties of the patterning device from the optical properties of the rest of the lithographic projection apparatus including at least the illumination and the projection optics (hence design layout model 235).

The resist model 237 can be used to calculate the resist image from the aerial image, an example of which can be found in U.S. Pat. No. 8,200,468, which is hereby incorporated by reference in its entirety. The resist model is typically related to properties of the resist layer (e.g., effects of chemical processes which occur during exposure, post-exposure bake and/or development).

One of the objectives of the full simulation is to accurately predict, for example, edge placements, aerial image intensity slopes and/or CDs, which can then be compared against an intended design. The intended design is generally defined as a pre-OPC design (or pattern) layout which can be provided in a standardized digital file format such as .GDS, .GDSII, .OASIS, or other file formats.

From the design (pattern) layout, one or more portions may be identified, which are referred to as “clips.” In an embodiment, a set of clips is extracted, which represents the complicated patterns in the design (pattern) layout (often hundreds or thousands of clips, although any number of clips may be used). As will be appreciated by those skilled in the art, these clips represent small portions (e.g., circuits, cells, etc.) of the design and may represent small portions for which particular attention and/or verification is needed. In other words, clips may be the portions of the design (pattern) layout or may be similar or have a similar behavior of portions of the design (pattern) layout where critical features are identified either by experience (including clips provided by a customer), by trial and error, or by running a full-chip simulation. Clips may contain one or more test patterns or gauge patterns. An initial larger set of clips may be provided a priori by a customer based on known critical feature areas in a design (pattern) layout which require particular image optimization. Alternatively, in another embodiment, the initial larger set of clips may be extracted from the entire design (pattern) layout by using an automated (such as, machine vision) or manual algorithm that identifies the critical feature areas.

Clips of the design (pattern) layout are often selected such that individual clips comprise different combinations of one or more (e.g., geometrically) unique patterns of the design (pattern) layout. The number of clips that include these geometrically unique patterns is typically very large, and is generally not capped or otherwise controlled. Often, several of the different portions (e.g., clips) have geometry that is only slightly different, and include a large amount of redundant information from one clip to the next.

Based on the clips (and/or other information), simulation and modeling can be used to configure one or more features of the patterning device pattern (e.g., performing optical proximity correction), one or more features of the illumination (e.g., changing one or more characteristics of a spatial/angular intensity distribution of the illumination, such as change a shape), and/or one or more features of the projection optics (e.g., numerical aperture, etc.). Such configuration can be generally referred to as, respectively, mask optimization, source optimization, and projection optimization. Such optimization can be performed on their own, or combined in different combinations. One such example is source-mask optimization (SMO), which involves the configuring of one or more features of the patterning device pattern together with one or more features of the illumination. The optimization techniques may focus on one or more of the clips.

Similar modelling techniques may be applied for optimizing an etching process, for example, and/or other processes. In some embodiments, illumination model 231, projection optics model 232, design layout model 235, resist model 237, and/or other models may be used in conjunction with an etch model, for example. For example, output from an after development inspection (ADI) model (e.g., included as some and/or all of design layout model 235, resist model 237, and/or other models) may be used to determine an ADI contour, which may be provided to an effective etch bias (EEB) model to generate a predicted after etch inspection (AEI) contour.

In some embodiments, an optimization process of a system may be represented as a cost function. The optimization process may comprise finding a set of parameters (design variables, process variables, etc.) of the system that minimizes the cost function. The cost function can have any suitable form depending on the goal of the optimization. For example, the cost function can be weighted root mean square (RMS) of deviations of certain characteristics (evaluation points) of the system with respect to the intended values (e.g., ideal values) of these characteristics. The cost function can also be the maximum of these deviations (i.e., worst deviation). The term “evaluation points” should be interpreted broadly to include any characteristics of the system or fabrication method. The design and/or process variables of the system can be confined to finite ranges and/or be interdependent due to practicalities of implementations of the system and/or method. In the case of a lithographic projection apparatus, the constraints are often associated with physical properties and characteristics of the hardware such as tunable ranges, and/or patterning device manufacturability design rules. The evaluation points can include physical points on a resist image on a substrate, as well as non-physical characteristics such as one or more etching parameters, dose and focus, etc., for example.

In an etching system, as an example, a cost function (CF) may be expressed as

$$CF ( {z}_{1} , {z}_{2} , … , {z}_{N} ) = {\sum }_{p = 1}^{P} {w}_{p} {f}_{p}^{2} ( {z}_{1} , {z}_{2} , … , {z}_{N} )$$

where (z₁, z₂, . . . , z_{N}) are N design variables or values thereof, and fₚ(z₁, z₂, . . . , z_{N}) can be a function of the design variables (z₁, z₂, . . . , z_{N}) such as a difference between an actual value and an intended value of a characteristic for a set of values of the design variables of (z₁, z₂, . . . , z_{N}). In some embodiments, wₚ is a weight constant associated with fₚ(z₁, z₂, . . . , z_{N}). For example, the characteristic may be a position of an edge of a pattern, measured at a given point on the edge. Different fₚ(z₁, z₂, . . . , z_{N}) may have different weight wₚ. For example, if a particular edge has a narrow range of permitted positions, the weight wₚ for the fₚ(z₁, z₂, . . . , z_{N}) representing the difference between the actual position and the intended position of the edge may be given a higher value. fₚ(z₁, z₂, . . . , z_{N}) can also be a function of an interlayer characteristic, which is in turn a function of the design variables (z₁, z₂, . . . , z_{N}). Of course, CF(z₁, z₂, . . . , z_{N}) is not limited to the form in the equation above and CF(z₁, z₂, . . . , z_{N}) can be in any other suitable form.

The cost function may represent any one or more suitable characteristics of the etching system, etching process, lithographic apparatus, lithography process, or the substrate, for instance, focus, CD, image shift, image distortion, image rotation, stochastic variation, throughput, local CD variation, process window, an interlayer characteristic, or a combination thereof. In some embodiments, the cost function may include a function that represents one or more characteristics of a resist image. For example, fₚ(z₁, z₂, . . . , z_{N}) can be simply a distance between a point in the resist image to an intended position of that point (i.e., edge placement error EPEₚ(z₁, z₂, . . . , z_{N}) after etching, for example, and/or some other process. The parameters (e.g., design variables) can include any adjustable parameter such as an adjustable parameter of the etching system, the source, the patterning device, the projection optics, dose, focus, etc.

The parameters (e.g., design variables) may have constraints, which can be expressed as (z₁, z₂, . . . , z_{N})∈Z, where Z is a set of possible values of the design variables. One possible constraint on the design variables may be imposed by a desired throughput of the lithographic projection apparatus. Without such a constraint imposed by the desired throughput, the optimization may yield a set of values of the design variables that are unrealistic. Constraints should not be interpreted as a necessity.

In some embodiments, illumination model 231, projection optics model 232, design layout model 235, resist model 237, an etch model, and/or other models associated with and/or included in an integrated circuit manufacturing process may be an empirical and/or other simulation model. The empirical model may predict outputs based on correlations between various inputs (e.g., one or more characteristics of a pattern such as curvature, one or more characteristics of the patterning device, one or more characteristics of the illumination used in the lithographic process such as the wavelength, etc.).

As an example, the empirical model may be a machine learning model and/or any other parameterized model. In some embodiments, the machine learning model (for example) may be and/or include mathematical equations, algorithms, plots, charts, networks (e.g., neural networks), and/or other tools and machine learning model components. For example, the machine learning model may be and/or include one or more neural networks having an input layer, an output layer, and one or more intermediate or hidden layers. In some embodiments, the one or more neural networks may be and/or include deep neural networks (e.g., neural networks that have one or more intermediate or hidden layers between the input and output layers).

As an example, the one or more neural networks may be based on a large collection of neural units (or artificial neurons). The one or more neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some embodiments, each individual neural unit may have a summation function that combines the values of all its inputs together. In some embodiments, each connection (or the neural unit itself) may have a threshold function such that a signal must surpass the threshold before it is allowed to propagate to other neural units. These neural network systems may be self-learning and trained, rather than explicitly programmed, and can perform significantly better in certain areas of problem solving, as compared to traditional computer programs. In some embodiments, the one or more neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for the one or more neural networks may be freer flowing, with connections interacting in a more chaotic and complex fashion. In some embodiments, the intermediate layers of the one or more neural networks include one or more convolutional layers, one or more recurrent layers, and/or other layers.

The one or more neural networks may be trained (i.e., whose parameters are determined) using a set of training information. The training information may include a set of training samples. Each sample may be a pair comprising an input object (typically a vector, which may be called a feature vector) and a desired output value (also called the supervisory signal). A training algorithm analyzes the training information and adjusts the behavior of the neural network by adjusting the parameters (e.g., weights of one or more layers) of the neural network based on the training information. For example, given a set of N training samples of the form {(x₁, y₁), (x₂, y₂), . . . , (x_{N}, y_{N})} such that xᵢ is the feature vector of the i-th example and yᵢ is its supervisory signal, a training algorithm seeks a neural network g: X→Y, where X is the input space and Y is the output space. A feature vector is an n-dimensional vector of numerical features that represent some object (e.g., a simulated aerial image, a wafer design, a clip, etc.). The vector space associated with these vectors is often called the feature space. After training, the neural network may be used for making predictions using new samples.

As another example, the empirical (simulation) model may comprise one or more algorithms. The one or more algorithms may be and/or include mathematical equations, plots, charts, and/or other tools and model components.

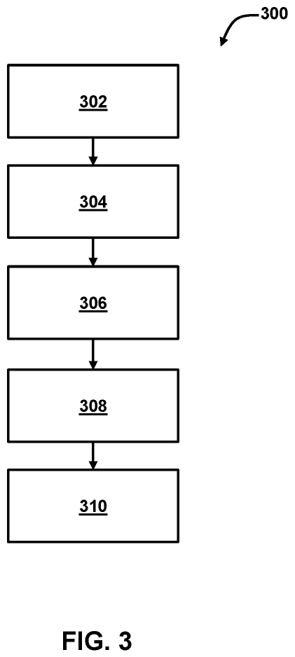

FIG. 3 illustrates an exemplary method 300 of selecting representative portions (e.g., clips or patches) of a pattern layout, according to an embodiment of the present disclosure. Method 300 is a method for selecting an optimized, geometrically diverse subset of representative portions for a pattern layout (e.g. a design layout). In some embodiments, method 300 comprises receiving 302 an original (e.g., a complete) representation of the pattern layout, determining 304 a set of representative portions (e.g., clips) of the pattern layout by grouping 306 patterns that repeat across the pattern layout (e.g., a geometric pattern that repeats in several location across a pattern layout) in the representative portions, selecting 308 a subset of representative portions, and providing 310 the subset of representative portions for various downstream applications.

In some embodiments, a non-transitory computer readable medium stores instructions which, when executed by a computer, cause the computer to execute one or more of operations 302-310, and/or other operations. The operations of method 300 are intended to be illustrative. In some embodiments, method 300 may be accomplished with one or more additional operations not described, and/or without one or more of the operations discussed. For example, operation 310 and/or other operations may be optional. Additionally, the order in which the operations of method 300 are illustrated in FIG. 3 and described herein is not intended to be limiting.

At an operation 302, a representation of a pattern layout is received. The representation of the pattern layout may be and/or include all or substantially all of the patterns of a pattern layout. This may be considered an original or complete representation, for example. The representation may comprise a simulation, an image, and electronic file, and/or other representations. The representation may include information describing patterns of the pattern layout themselves and/or information related to the patterns. The patterns may include the geometrical shapes of contours in the pattern layout and/or information related to the geometrical shapes. Using a semiconductor chip as an example, a representation of a pattern layout may include all (or substantially all) of the patterns that make up a chip design (e.g., including pattern layout structures configured to facilitate inspections and/or other operations). This may include channels, protrusions, vias, gratings, etc., as shown in a simulation, an image, a .GDS file, etc.

In some embodiments, the representative portion selection or pattern selection may be based on pattern polygons obtained directly from a layout design. In some other embodiments, the representative portion selection or pattern selection may be based on pattern images or contours of the pattern layout, where the images or contours can be obtained from any suitable inspection or metrology system, or simulation. For example, the selection may be based on aerial images, optical images, mask images, resist images, etch images, wafer image of the patterns as measured or simulated.

The patterns in a pattern layout may include two and/or three dimensional geometrical shapes, for example. The received representation includes data that describes the characteristics of the shapes (e.g., such as X-Y dimensional data points, a mathematical equation that describes the geometrical shape, etc.), processing parameters associated with the shapes, and/or other data. In some embodiments, the representation of the pattern layout may comprise inspection results from an after development inspection (ADI) for the pattern layout (e.g., from a previously inspected wafer), a model of the pattern in the pattern layout, and/or other information. The inspection results from the after development inspection for the pattern layout may be obtained from a scanning electron microscope, an optical metrology tool, and/or other sources. In some embodiments, the patterns may be obtained from aerial images, mask images, etch images, or etc., that result from a resist model (e.g., as shown in FIG. 2 and described above), an optical model (e.g., as shown in FIG. 2 and described above), an etch model, an etch bias model and/or other modelling sources.

In some embodiments, the representation of the pattern layout comprises a .GDS file, a .GDSII file, a .OASIS file, and/or an electronic file having other file formats, and/or another electronic representation of the pattern layout. The representation may be received electronically from one or more other portions of the present system (e.g., from a different processor, or from a different portion of a single processor), from a remote computing system not associated with a present system, and/or from other sources. The representation may be received wirelessly and/or via wires, via a portable storage medium, and/or from other sources. The representation may be uploaded and/or downloaded from another source, such as cloud storage for example, and/or received in other ways.

At an operation 304, a set of representative portions (e.g., clips or patches) of the pattern layout is determined. The representative portions may represent different portions of the pattern layout. The representative portions may include several different unique representative portions from the pattern layout. In some embodiments, as described above, the pattern layout comprises a design layout for a semiconductor wafer, for example, and the representative portions comprise clips of the design layout. In some embodiments, the pattern layout comprises a design layout for a different device, for example, and the representative portions comprise different portions of the different device.

Individual representative portions (e.g., clips or patches) comprise one or more unique patterns of the pattern layout (e.g., design layout). A pattern may be unique geometrically, for example, and/or for other reasons. In other words, a clip in a determined set of clips can include one or more geometrically unique patterns of a design layout. The set of representative portions of the pattern layout is determined such that the individual representative portions comprise different combinations of the one or more unique patterns. In some cases, at least one of the unique patterns is included in more than one representative portion.

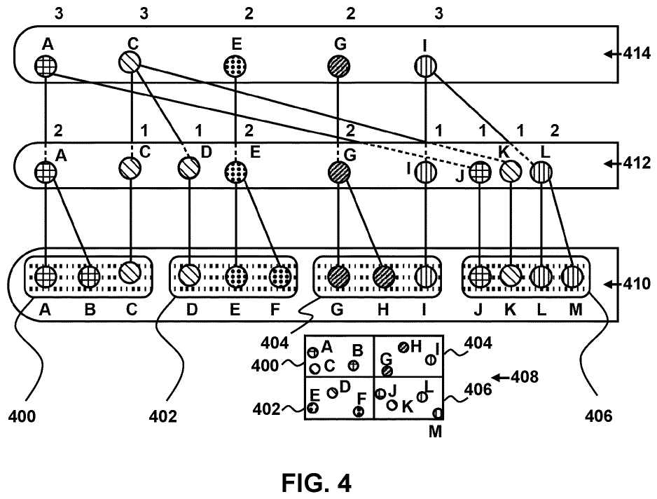

FIG. 4 illustrates additional detail related to determining the set of representative portions (e.g., clips) of a pattern layout. FIG. 4 illustrates individual representative portions (e.g., clips) 400, 402, 404, and 406 comprising one or more unique patterns A-M of the pattern layout (e.g., design layout). In other words, a clip 400-406 in a determined set of clips (e.g., the group of clips including clips 400-406) can include one or more identified unique patterns A-M of a design layout. As shown in FIG. 4, the set of representative portions (e.g., clips) 400-406 of the pattern layout is determined such that the individual representative portions (clips) 400-406 comprise different combinations of the one or more unique patterns A-M. In some embodiments, a pattern can repeat within the same representative portion (e.g., clip), and/or across two or more representative portions (e.g., clips). In some embodiments, at least one of the patterns A-M is included in more than one representative portion (e.g., clip) 400-406. In this example, A, B, and J, are the same pattern, which repeats in clip 400 and clip 406. Patterns C, D, and K are the same pattern, which repeats in clips 400, 402, and 406.

Patterns E and F are the same pattern, which repeats in clip 402. Patterns G and H are the same pattern, which repeats in clip 404. Finally, patterns I, L, and M, are the same pattern, which repeats in clips 404 and 406.

In some embodiments, as shown in FIG. 4, a representation of a pattern layout may be received 408 (also see operation 302 in FIG. 3 described above). Patterns A-M may be identified 410 within a given clip 400-406. Repeating (identical or nearly identical, e.g., similar or like) patterns may be grouped together (e.g., by exact and/or fuzzy matching algorithms, clustering, etc.). Any repeating patterns A-M in each clip 400-406 may be grouped 412, and then the pattern groups may be further grouped 414 across the full pattern layout (design layout). Unique patterns (which may include identical and/or similar patterns as described above) may have repeating instances across a full pattern layout. In FIG. 4, repeating identical and/or similar patterns include patterns A, B, and I; patterns C, D, and K, patterns E and F; patterns G and H; and patterns I, L, and M; which are grouped together, for example. FIG. 4 illustrates a subtotal quantity for each pattern after being grouped 412 initially (e.g., 2, 1, 1, 2, 2, 1, 1, 1, 2), and a final total quantity for each pattern after being grouped 414 across the full pattern layout (e.g., 3, 3, 2, 2, 3).

Returning to FIG. 3, in some embodiments, the set of representative portions is determined by grouping 306 repeating identical and/or similar patterns in the representative portions (e.g., as shown and described in FIG. 4). The set of the representative portions is determined based on grouped patterns and/or other information. In some embodiments, patterns that repeat across the pattern layout are grouped to determine the unique patterns, and the set of the representative portions is determined based on grouped patterns, and/or other information.

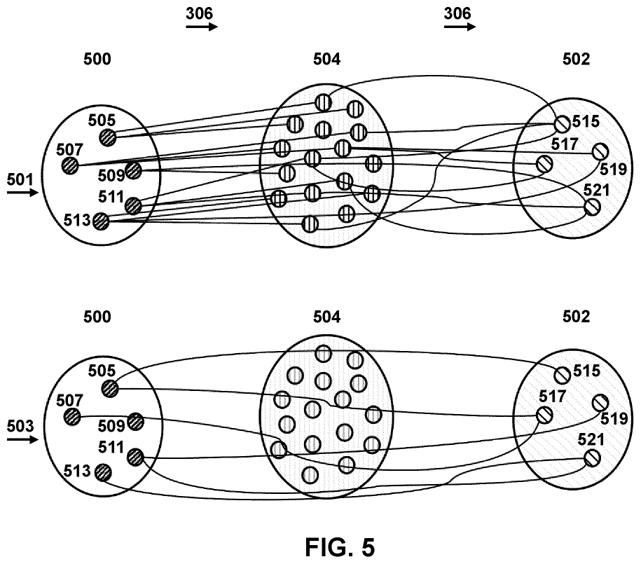

For example, FIG. 5 illustrates determining the set of representative portions (clips or patches) 500 based on groups 502 of repeating identical and/or similar patterns 504 in views 501 and 503. FIG. 5 illustrates a connection graph between clips 500, patterns 504, and groups 502. As shown in view 501, the set of representative portions (e.g., the set of clips 500) is determined by grouping 306 repeating identical and/or similar patterns 504 in the representative portions (also see 412 and 414 shown and described in FIG. 4) into groups 502. As shown in view 503, the set of the representative portions (clips) 500 is determined based on groups 502 of repeating identical and/or similar patterns 504, such that the set of the representative portions (clips) 500 includes a unique pattern (504) from each group 502. In the example shown in FIG. 5, a pattern from a group 515 is included in a clip 505. Patterns from a group 517 are included in clips 505 and 513. A pattern from a group 519 is included in a clip 511. Patterns from a group 521 are included in clips 507 and 511.

Returning to FIG. 3, at an operation 308, a subset of representative portions (e.g., clips or patches) is selected and/or otherwise determined. The subset of the representative portions is selected such that the representative portions in the subset meet a certain quantity criterion, and that the geometrically unique patterns encompassed in the subset also meet a certain diversity or quantity criterion. The subset of the representative portions is determined based on the one or more unique patterns, the groups, and/or other information. In addition, portions in the subset of representative portions may be determined such than an amount of redundancy in identical and/or similar patterns between representative portions is minimized, and the subset of representative portions includes diverse geometric information about the pattern layout.

In some embodiments, this results in a number of the representative portions in the subset of

the representative portions being less than a number of representative portions in the set of representative portions by a factor of about 10. In some embodiments, a number of the representative portions in the subset of the representative portions is less than a number of representative portions in the set of representative portions by a factor of about 100. In some embodiments, a number of the representative portions in the subset of the representative portions is less than a number of representative portions in the set of representative portions by a factor of about 1000. As described above, this can significantly reduce required computing resources, and speed later computing processes (e.g., electronic modelling and/or other computing processes), among other advantages.

The subset of the representative portions is selected, in combination, based on the one or more unique patterns, the groups, and/or other information. The selected subset of the representative portions comprises a number of unique patterns that meet a prescribed criterion. In some embodiments, the prescribed criterion comprises inclusion of at least a threshold number of unique patterns in the selected subset of the representative portions. The threshold number is configured to ensure that, in combination, the unique patterns included in the selected subset of representative portions provides adequate pattern overage, for example represent an entirety (or almost an entirety) of the pattern layout, for example. The threshold number may be or correspond to the number of unique patterns, for example, and/or be other threshold numbers. A threshold number may be set by a user; set automatically based on the unique patterns, the set of representative portions of the pattern layout, and/or other information; and/or set in other ways. For example, the subset of the representative portions may be configured to include each geometrically unique pattern in the minimum (or fewest possible) number of representative portions.

In some embodiments, the selected subset of representative portions contains an optimally diverse group of unique patterns, and has a less than a prescribed limit number of representative portions. The optimally diverse group of unique patterns comprises a plurality of unique patterns having geometries that, in combination, represent as much of the pattern layout as possible, given the predetermined number of representative portions that form the selected subset. In some embodiments, the selected subset of representative portions may have as many geometrically unique patterns of the pattern layout as possible in a maximum number of representative portions. In some embodiments, this maximum number is dictated by the subset selection algorithm or method, e.g., a set cover solver algorithm.

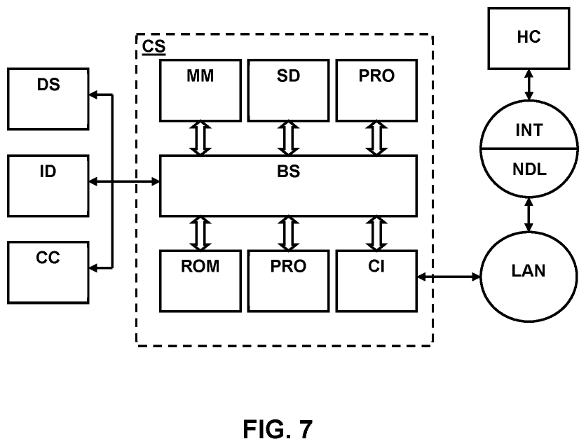

In some embodiments, selecting or otherwise determining the subset of the representative portions is performed by a discrete optimizer (e.g., the processor PRO shown in FIG. 7 and described below). The subset of the representative portions is optimized to include a maximum amount of unique geometry from the pattern layout. In some embodiments, the selected subset of the representative portions in combination includes at least a threshold number of unique patterns. In some embodiments, the selected subset of the representative portions in combination includes an optimally diverse group of unique patterns in less than a prescribed limit number of representative portions. In some embodiments, an optimizer can be implemented as a computer algorithm that finds the minimum of a given cost function. An optimizer may be a gradient based non-linear optimizer configured to co-determine multiple variables, for example. Here, the variables may include a number of unique patterns, a number of representative portions (e.g., clips), and/or other variables, for example. An optimizer may be configured to balance different possible variables (e.g., a number of unique patterns, a number of clips, etc., each within their own allowable ranges) against manufacturing capabilities or costs associated with different metrics (e.g., a critical dimension, a pattern layout placement error, an edge placement error, critical dimension asymmetry, a defect count, and/or other metrics that may be later generated based on modelling). The discrete optimizer may use integer linear programming and/or other techniques to determine the subset of the representative portions.

In some embodiments, the discrete optimizer can be implemented to include a set cover solver that is configured to execute set cover solver algorithms. For example, in some embodiments, the discrete optimizer is configured such that, given a set of n unique patterns, E={E1, E2, . . . . En} (so-called the universe) and a collection of clips with different pattern layouts whose union equals the universe, operation 308 comprises identifying the smallest sub-collection of clips whose union equals the universe of patterns. In some embodiments, the discrete optimizer is configured such that, given the set of n unique patterns, E={E1, E2, . . . . En} and a collection of clips with different pattern layouts whose union equals the universe, operation 308 comprises identifying a selected subset of representative portions that contains an optimally diverse group of unique patterns, and has a less than a prescribed limit number of representative portions (e.g., identifying a maximum number of clips whose union comes as close as possible to (e.g., is optimized to best represent) the universe of patterns).

In some embodiments, when the subset of the representative portions (clips) contains an optimally diverse group of unique patterns, and has a less than a prescribed limit number of representative portions, the subset of the representative portions can be ranked based on the one or more unique patterns they include. In some embodiments, the subset of the representative portions are ranked based on a quantity and/or a rarity of the one or more unique patterns each representative portion includes and/or other information. The subset of the representative portions is determined based on the rank and/or other information. For example, clips with the highest rank may be chosen in order, until the prescribed limit (e.g., a maximum allowable) number of representative portions (clips) is reached.

In some embodiments, the prescribed limit and/or maximum number of representative portions can be set by a user or automatically. For example, the prescribed and/or maximum number of representative portions may be entered via one or more fields in one or more views of a graphical user interface (e.g., controlled and/or displayed by the computing system shown in FIG. 7 and described below). In some embodiments, the prescribed and/or maximum number of representative portions is determined electronically (e.g., by a processor such as PRO shown in FIG. 7). In some embodiments, the user set prescribed and/or maximum, and/or the electronically determined prescribed and/or maximum, may be determined based on a target quantity of representative target portions, computer power and/or storage associated with available computing resources, a manufacturing process associated with the representative portions, throughput requirements, and/or other information.

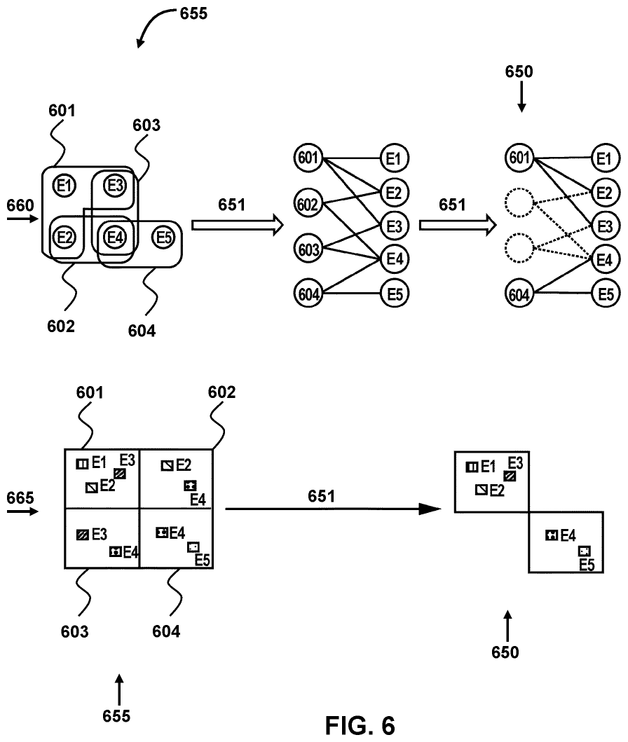

FIG. 6 illustrates an example of selecting 651 a subset 650 of representative portions (e.g., clips) 601-604, in views 660 and 665. For ease of understanding, views 660 and 665 illustrate two versions of the same selecting 651 process, but with different graphics (e.g., view 660 provides constraint graph graphics). Subset 650 of representative portions is selected from the determined set 655 of representative portions (e.g., clips 601-604 form set 655 in this example) and includes fewer representative portions (e.g., subset 650 includes two clips 601 and 604 in this example) than the number of representative portions in (the full) set 655 (e.g., which includes four clips 601-604 in this example). Subset 650 of the representative portions is determined based on the one or more unique patterns (e.g., E1-E5 in this example, which may already be grouped as described above), and/or other information. Subset 650 of representative portions (clips) 601-604 is selected such that each representative portion (clip) 601 and 604 in the subset 650 of the representative portions includes a different arrangement of the one or more unique patterns (e.g., E1-E3 in portion (clip) 601 and E4-E5 in portion (clip) 604) relative to other representative portions in subset 650 of representative portions (clips) 601-604). In addition, portions (clips) 601 and 604 in subset 650 are determined 651 such than an amount of redundancy in unique patterns (E1-E5) between candidate portions (clips) 601-604 is minimized, and subset 650 includes diverse geometric information about the pattern layout. In the example shown in FIG. 6, only portions (clips) 601 and 604 were selected because those two clips in combination include at least one instance of each of patterns E1-E5. Clips 602 and 603 include redundant information (e.g., additional instances of E2, E3, and E4).

Returning to FIG. 3, at an operation 310, the subset of representative portions is provided for various downstream applications. In some embodiments, operation 310 includes providing the selected subset of representative portions for inspection or metrology. The patterns or data associated with the patterns can be used as calibration data for a physical, semi-physical or empirical model, or used as training data for training a machine learning model. The data associated with the patterns may be simulated data or inspection or metrology data associated with the patterns. In some embodiments, one or more of the selected subset of representative portions may be provided as input to a trained machine learning model for the purpose of generating a prediction (output) from the model (e.g., a prediction about a semiconductor manufacturing process). Providing may include electronically sending, uploading, and/or otherwise inputting a representative portion to a machine learning simulation model. In some embodiments, the simulation model may be integrally programmed with the instructions that cause others of operations 302-310 (e.g., such that no “providing” is required, and instead data simply flows directly to a simulation model).

For example, one or more of the subset of representative portions may be provided to one or more machine learning simulation models. A simulation model may be configured to predict an impact one or more geometrically unique features may have on the patterning process (e.g., as described above). For example, a machine learning model may be associated with optical proximity correction (OPC), hotspot or defect prediction, and/or source mask optimization (SMO) for a semiconductor lithography process, and/or other operations. As described above, selecting an optimal subset of clips for training can save runtime during model training and/or execution operations, and/or have other advantages.

Adjustments to a semiconductor manufacturing process may be made based on the output from such a model. Adjustments may including changing one or more semiconductor manufacturing process parameters, for example. Adjustments may include pattern parameter changes (e.g., sizes, locations, and/or other design variables), and/or any adjustable parameter such as an adjustable parameter of the etching system, the source, the patterning device, the projection optics, dose, focus, etc. Parameters may be automatically or otherwise electronically adjusted by a processor (e.g., a computer controller), modulated manually by a user, or adjusted in other ways. In some embodiments, parameter adjustments may be determined (e.g., an amount a given parameter should be changed), and the parameters may be adjusted from prior parameter set points to new parameter set points, for example.

FIG. 7 is a diagram of an example computer system CS that may be used for one or more of the operations described herein. Computer system CS includes a bus BS or other communication mechanism for communicating information, and a processor PRO (or multiple processors) coupled with bus BS for processing information. Computer system CS also includes a main memory MM, such as a random access memory (RAM) or other dynamic storage device, coupled to bus BS for storing information and instructions to be executed by processor PRO. Main memory MM also may be used for storing temporary variables or other intermediate information during execution of instructions by processor PRO. Computer system CS further includes a read only memory (ROM) ROM or other static storage device coupled to bus BS for storing static information and instructions for processor PRO. A storage device SD, such as a magnetic disk or optical disk, is provided and coupled to bus BS for storing information and instructions.

Computer system CS may be coupled via bus BS to a display DS, such as a cathode ray tube (CRT) or flat panel or touch panel display for displaying information to a computer user. An input device ID, including alphanumeric and other keys, is coupled to bus BS for communicating information and command selections to processor PRO. Another type of user input device is cursor control CC, such as a mouse, a trackball, or cursor direction keys for communicating direction information and command selections to processor PRO and for controlling cursor movement on display DS. This input device typically has two degrees of freedom in two axes, a first axis (e.g., x) and a second axis (e.g., y), that allows the device to specify positions in a plane. A touch panel (screen) display may also be used as an input device.

In some embodiments, portions of one or more methods described herein may be performed by computer system CS in response to processor PRO executing one or more sequences of one or more instructions contained in main memory MM. Such instructions may be read into main memory MM from another computer-readable medium, such as storage device SD. Execution of the sequences of instructions included in main memory MM causes processor PRO to perform the process steps (operations) described herein. One or more processors in a multi-processing arrangement may also be employed to execute the sequences of instructions contained in main memory MM. In some embodiments, hard-wired circuitry may be used in place of or in combination with software instructions. Thus, the description herein is not limited to any specific combination of hardware circuitry and software.

The term “computer-readable medium” as used herein refers to any medium that participates in providing instructions to processor PRO for execution. Such a medium may take many forms, including but not limited to, non-volatile media, volatile media, and transmission media. Non-volatile media include, for example, optical or magnetic disks, such as storage device SD. Volatile media include dynamic memory, such as main memory MM. Transmission media include coaxial cables, copper wire and fiber optics, including the wires that comprise bus BS. Transmission media can also take the form of acoustic or light waves, such as those generated during radio frequency (RF) and infrared (IR) data communications. Computer-readable media can be non-transitory, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge. Non-transitory computer readable media can have instructions recorded thereon. The instructions, when executed by a computer, can implement any of the operations described herein. Transitory computer-readable media can include a carrier wave or other propagating electromagnetic signal, for example.

Various forms of computer readable media may be involved in carrying one or more sequences of one or more instructions to processor PRO for execution. For example, the instructions may initially be borne on a magnetic disk of a remote computer. The remote computer can load the instructions into its dynamic memory and send the instructions over a telephone line using a modem. A modem local to computer system CS can receive the data on the telephone line and use an infrared transmitter to convert the data to an infrared signal. An infrared detector coupled to bus BS can receive the data carried in the infrared signal and place the data on bus BS. Bus BS carries the data to main memory MM, from which processor PRO retrieves and executes the instructions. The instructions received by main memory MM may optionally be stored on storage device SD either before or after execution by processor PRO.

Computer system CS may also include a communication interface CI coupled to bus BS. Communication interface CI provides a two-way data communication coupling to a network link NDL that is connected to a local network LAN. For example, communication interface CI may be an integrated services digital network (ISDN) card or a modem to provide a data communication connection to a corresponding type of telephone line. As another example, communication interface CI may be a local area network (LAN) card to provide a data communication connection to a compatible LAN. Wireless links may also be implemented. In any such implementation, communication interface CI sends and receives electrical, electromagnetic, or optical signals that carry digital data streams representing various types of information.

Network link NDL typically provides data communication through one or more networks to other data devices. For example, network link NDL may provide a connection through local network LAN to a host computer HC. This can include data communication services provided through the worldwide packet data communication network, now commonly referred to as the “Internet” INT. Local network LAN (Internet) may use electrical, electromagnetic, or optical signals that carry digital data streams. The signals through the various networks and the signals on network data link NDL and through communication interface CI, which carry the digital data to and from computer system CS, are exemplary forms of carrier waves transporting the information.

Computer system CS can send messages and receive data, including program code, through the network(s), network data link NDL, and communication interface CI. In the Internet example, host computer HC might transmit a requested code for an application program through Internet INT, network data link NDL, local network LAN, and communication interface CI. One such downloaded application may provide all or part of a method described herein, for example. The received code may be executed by processor PRO as it is received, and/or stored in storage device SD, or other non-volatile storage for later execution. In this manner, computer system CS may obtain application code in the form of a carrier wave.

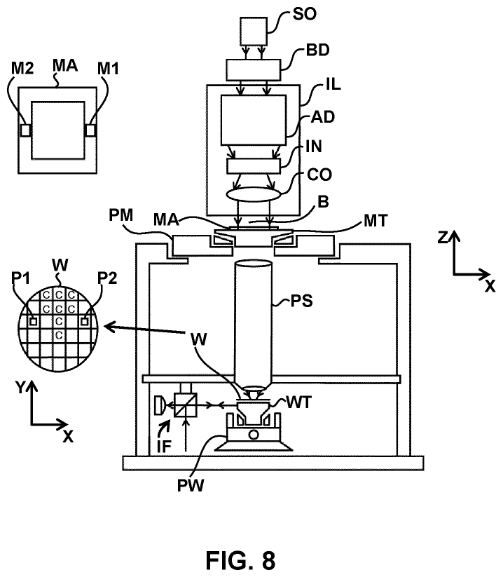

FIG. 8 is a schematic diagram of a lithographic projection apparatus, according to an embodiment. The lithographic projection apparatus can include an illumination system IL, a first object table MT, a second object table WT, and a projection system PS. Illumination system IL, can condition a beam B of radiation. In this example, the illumination system also comprises a radiation source SO. First object table (e.g., a patterning device table) MT can be provided with a patterning device holder to hold a patterning device MA (e.g., a reticle), and connected to a first positioner to accurately position the patterning device with respect to item PS. Second object table (e.g., a substrate table) WT can be provided with a substrate holder to hold a substrate W (e.g., a resist-coated silicon wafer), and connected to a second positioner to accurately position the substrate with respect to item PS. Projection system (e.g., which includes a lens) PS (e.g., a refractive, catoptric or catadioptric optical system) can image an irradiated portion of the patterning device MA onto a target portion C (e.g., comprising one or more dies) of the substrate W. Patterning device MA and substrate W may be aligned using patterning device alignment marks M1, M2 and substrate alignment marks P1, P2, for example.

As depicted, the apparatus can be of a transmissive type (i.e., has a transmissive patterning device). However, in general, it may also be of a reflective type, for example (with a reflective patterning device). The apparatus may employ a different kind of patterning device for a classic mask; examples include a programmable mirror array or LCD matrix.

The source SO (e.g., a mercury lamp or excimer laser, LPP (laser produced plasma) EUV source) produces a beam of radiation. This beam is fed into an illumination system (illuminator) IL, either directly or after having traversed conditioning means, such as a beam expander, or beam delivery system BD (comprising directing mirrors, the beam expander, etc.). for example. The illuminator IL may comprise adjusting means AD for setting the outer and/or inner radial extent (commonly referred to as o-outer and o-inner, respectively) of the intensity distribution in the beam. In addition, it will generally comprise various other components, such as an integrator IN and a condenser CO. In this way, the beam B impinging on the patterning device MA has a desired uniformity and intensity distribution in its cross-section.

In some embodiments, source SO may be within the housing of the lithographic projection apparatus (as is often the case when source SO is a mercury lamp, for example), but that it may also be remote from the lithographic projection apparatus. The radiation beam that it produces may be led into the apparatus (e.g., with the aid of suitable directing mirrors), for example. This latter scenario can be the case when source SO is an excimer laser (e.g., based on KrF, ArF or F2 lasing), for example.

The beam B can subsequently intercept patterning device MA, which is held on a patterning device table MT. Having traversed patterning device MA, the beam B can pass through the lens PL, which focuses beam B onto target portion C of substrate W. With the aid of the second positioning means (and interferometric measuring means IF), the substrate table WT can be moved accurately, e.g. to position different target portions C in the path of beam B. Similarly, the first positioning means can be used to accurately position patterning device MA with respect to the path of beam B, e.g., after mechanical retrieval of the patterning device MA from a patterning device library, or during a scan. In general, movement of the object tables MT, WT can be realized with the aid of a long-stroke module (coarse positioning) and a short-stroke module (fine positioning). However, in the case of a stepper (as opposed to a step-and-scan tool), patterning device table MT may be connected to a short stroke actuator, or may be fixed.

The depicted tool can be used in two different modes, step mode and scan mode. In step mode, patterning device table MT is kept essentially stationary, and an entire patterning device image is projected in one operation (i.e., a single “flash”) onto a target portion C. Substrate table WT can be shifted in the x and/or y directions so that a different target portion C can be irradiated by beam B. In scan mode, essentially the same scenario applies, except that a given target portion C is not exposed in a single “flash.” Instead, patterning device table MT is movable in a given direction (e.g., the “scan direction”, or the “y” direction) with a speed v, so that projection beam B is caused to scan over a patterning device image. Concurrently, substrate table WT is simultaneously moved in the same or opposite direction at a speed V=Mv, in which M is the magnification of the lens (typically, M=¼ or ⅕). In this manner, a relatively large target portion C can be exposed, without having to compromise on resolution.

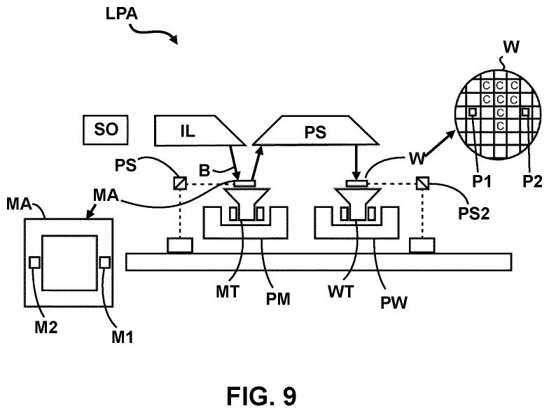

FIG. 9 is a schematic diagram of another lithographic projection apparatus (LPA) that may be used for, and/or facilitating one or more of the operations described herein. LPA can include source collector module SO, illumination system (illuminator) IL configured to condition a radiation beam B (e.g. EUV radiation), support structure MT, substrate table WT, and projection system PS. Support structure (e.g. a patterning device table) MT can be constructed to support a patterning device (e.g. a mask or a reticle) MA and connected to a first positioner PM configured to accurately position the patterning device. Substrate table (e.g. a wafer table) WT can be constructed to hold a substrate (e.g. a resist coated wafer) W and connected to a second positioner PW configured to accurately position the substrate. Projection system (e.g. a reflective projection system) PS can be configured to project a pattern imparted to the radiation beam B by patterning device MA onto a target portion C (e.g. comprising one or more dies) of the substrate W.

As shown in this example, LPA can be of a reflective type (e.g. employing a reflective patterning device). It is to be noted that because most materials are absorptive within the EUV wavelength range, the patterning device may have multilayer reflectors comprising, for example, a multi-stack of molybdenum and silicon. In one example, the multi-stack reflector has a 40 layer pairs of molybdenum and silicon where the thickness of each layer is a quarter wavelength. Even smaller wavelengths may be produced with X-ray lithography. Since most material is absorptive at EUV and x-ray wavelengths, a thin piece of patterned absorbing material on the patterning device topography (e.g., a TaN absorber on top of the multi-layer reflector) defines where features would print (positive resist) or not print (negative resist).

Illuminator IL can receive an extreme ultra violet radiation beam from source collector module SO. Methods to produce EUV radiation include, but are not necessarily limited to, converting a material into a plasma state that has at least one element, e.g., xenon, lithium, or tin, with one or more emission lines in the EUV range. In one such method, often termed laser produced plasma (“LPP”), the plasma can be produced by irradiating a fuel, such as a droplet, stream or cluster of material having the line-emitting element, with a laser beam. Source collector module SO may be part of an EUV radiation system including a laser (not shown in FIG. 9), for providing the laser beam exciting the fuel. The resulting plasma emits output radiation, e.g., EUV radiation, which is collected using a radiation collector, disposed in the source collector module. The laser and the source collector module may be separate entities, for example when a CO2 laser is used to provide the laser beam for fuel excitation. In this example, the laser may not be considered to form part of the lithographic apparatus and the radiation beam can be passed from the laser to the source collector module with the aid of a beam delivery system comprising, for example, suitable directing mirrors and/or a beam expander. In other examples, the source may be an integral part of the source collector module, for example when the source is a discharge produced plasma EUV generator, often termed a DPP source.

Illuminator IL may comprise an adjuster for adjusting the angular intensity distribution of the radiation beam. Generally, at least the outer and/or inner radial extent (commonly referred to as o-outer and o-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross section.

The radiation beam B can be incident on the patterning device (e.g., mask) MA, which is held on the support structure (e.g., patterning device table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor PS2 (e.g. an interferometric device, linear encoder, or capacitive sensor), the substrate table WT can be moved accurately (e.g. to position different target portions C in the path of radiation beam B). Similarly, the first positioner PM and another position sensor PS1 can be used to accurately position the patterning device (e.g. mask) MA with respect to the path of the radiation beam B. Patterning device (e.g. mask) MA and substrate W may be aligned using patterning device alignment marks M1, M2 and substrate alignment marks P1, P2.

The depicted apparatus LPA could be used in at least one of the following modes, step mode, scan mode, and stationary mode. In step mode, the support structure (e.g. patterning device table) MT and the substrate table WT are kept essentially stationary, while an entire pattern imparted to the radiation beam is projected onto a target portion C at one time (e.g., a single static exposure). The substrate table WT is then shifted in the X and/or Y direction so that a different target portion C can be exposed. In scan mode, the support structure (e.g. patterning device table) MT and the substrate table WT are scanned synchronously while a pattern imparted to the radiation beam is projected onto target portion C (i.e. a single dynamic exposure). The velocity and direction of substrate table WT relative to the support structure (e.g. patterning device table) MT may be determined by the (de) magnification and image reversal characteristics of the projection system PS. In stationary mode, the support structure (e.g. patterning device table) MT is kept essentially stationary holding a programmable patterning device, and substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

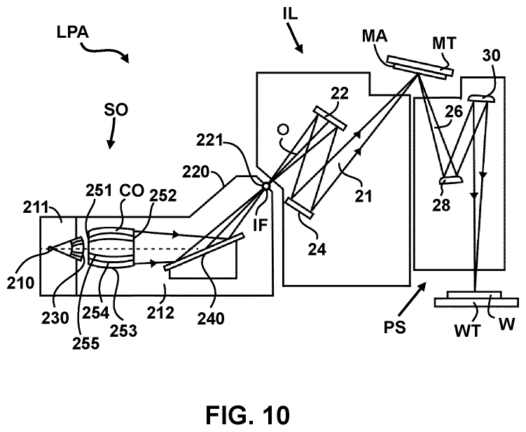

FIG. 10 is a detailed view of the lithographic projection apparatus shown in FIG. 9. As shown in FIG. 10, the LPA can include the source collector module SO, the illumination system IL, and the projection system PS. The source collector module SO is configured such that a vacuum environment can be maintained in an enclosing structure 220 of the source collector module SO. An EUV radiation emitting plasma 210 may be formed by a discharge produced plasma source. EUV radiation may be produced by a gas or vapor, for example Xe gas, Li vapor or Sn vapor in which the hot plasma 210 is created to emit radiation in the EUV range of the electromagnetic spectrum. The hot plasma 210 is created by, for example, an electrical discharge causing at least partially ionized plasma. Partial pressures of, for example, 10 Pa of Xe, Li, Sn vapor or any other suitable gas or vapor may be required for efficient generation of the radiation. In some embodiments, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contamination trap 230 may also include a gas barrier or a combination of a gas barrier and a channel structure. The contaminant trap or contaminant barrier trap 230 (described below) also includes a channel structure. The collector chamber 211 may include a radiation collector CO which may be a grazing incidence collector. Radiation collector CO has an upstream radiation collector side 251 and a downstream radiation collector side 252. Radiation that traverses collector CO can be reflected off a grating spectral filter 240 to be focused on a virtual source point IF along the optical axis indicated by the line “O”. The virtual source point IF is commonly referred to as the intermediate focus, and the source collector module is arranged such that the intermediate focus IF is located at or near an opening 221 in the enclosing structure 220. The virtual source point IF is an image of the radiation emitting plasma 210.

Subsequently, the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the radiation beam 21 at the patterning device MA, held by the support structure MT, a patterned beam 26 is formed and the patterned beam 26 is imaged by the projection system PS via reflective elements 28, 30 onto a substrate W held by the substrate table WT. More elements than shown may generally be present in illumination optics unit IL and projection system PS. The grating spectral filter 240 may optionally be present, depending upon the type of lithographic apparatus, for example. Further, there may be more mirrors present than those shown in the figures, for example there may be 1-6 additional reflective elements present in the projection system PS than shown in FIG. 10.

Collector optic CO, as illustrated in FIG. 10, is depicted as a nested collector with grazing incidence reflectors 253, 254 and 255, just as an example of a collector (or collector mirror). The grazing incidence reflectors 253, 254 and 255 are disposed axially symmetric around the optical axis O and a collector optic CO of this type may be used in combination with a discharge produced plasma source, often called a DPP source.

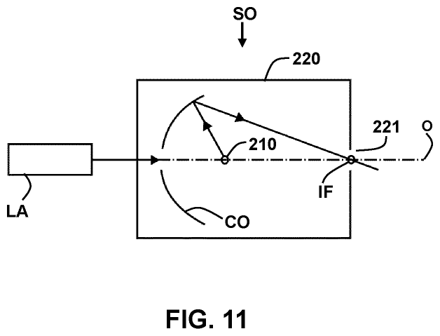

FIG. 11 is a detailed view of source collector module SO of the lithographic projection apparatus LPA (shown in previous figures). Source collector module SO may be part of an LPA radiation system. A laser LA can be arranged to deposit laser energy into a fuel, such as xenon (Xe), tin (Sn) or lithium (Li), creating the highly ionized plasma 210 with electron temperatures of several 10″s of eV. The energetic radiation generated during de-excitation and recombination of these ions is emitted from the plasma, collected by a near normal incidence collector optic CO and focused onto the opening 221 in the enclosing structure 220.

The concepts disclosed herein may simulate or mathematically model any generic imaging, etching, polishing, inspection, etc. system for sub wavelength features, and may be useful with emerging imaging technologies capable of producing increasingly shorter wavelengths. Emerging technologies include EUV (extreme ultra violet), DUV lithography that is capable of producing a 193 nm wavelength with the use of an ArF laser, and even a 157 nm wavelength with the use of a Fluorine laser. Moreover, EUV lithography is capable of producing wavelengths within a range of 20-50 nm by using a synchrotron or by hitting a material (either solid or a plasma) with high energy electrons in order to produce photons within this range.

Embodiment of the present disclosure can be further described by the following clauses.

1. A non-transitory computer readable medium having instructions thereon, the instructions when executed by a computer causing the computer to perform operations comprising:
receiving a set of representative portions of a pattern layout, wherein individual representative portions comprise one or more unique patterns of the pattern layout; and
selecting a subset of the representative portions from the set of representative portions according to a prescribed criterion for unique patterns included in the subset of representative portions in combination.

2. The medium of clause 1, wherein the subset of the representative portions is selected such that the representative portions in the subset meet a first criterion, and unique patterns encompassed in the subset also meet a second criterion.

3. The medium of clause 2, wherein the first criterion corresponds to a prescribed number of representative portions in the subset, and wherein the second criterion corresponds to including at least a threshold number of unique patterns in the prescribed number of representative portions in combination.

4. The medium of any of clauses 1-3, wherein selecting the subset of the representative portions comprises using a set cover solver algorithm.

5. The medium of clause 4, wherein the unique patterns in the set of representative portions of the pattern layout are configured as elements in a universe in the set cover solver algorithm.

6. The medium of any of clauses 1-5, wherein the prescribed criterion comprises inclusion of at least a threshold number of unique patterns from the set of representative portions of the pattern layout in the selected subset of the representative portions.

7. The medium of any of clauses 1-6, wherein the prescribed criterion is set such that the unique patterns included in the selected subset of representative portions in combination represent an entirety of the pattern layout or a portion of the pattern layout.

8. The medium of any of clauses 1-7, wherein the prescribed criterion comprises inclusion of an optimally diverse group of unique patterns in a predetermined number of representative portions that form the selected subset of representative portions.

9. The medium of clause 8, wherein the optimally diverse group of unique patterns comprises a plurality of unique patterns having geometries that, in combination, represent at least a threshold amount of the pattern layout, given the predetermined number of representative portions that form the selected subset.

10. The medium of any of clauses 1-9, wherein a unique pattern of the pattern layout comprises a pattern that is different than other patterns in a spatial window of interest in the pattern layout.

11. The medium of clause 10, wherein the unique pattern represents a group of identical or similar patterns across the pattern layout.

12. The medium of any of clauses 1-11, wherein the operations further comprise identifying unique patterns of the pattern layout by using exact matching, fuzzy matching, or a clustering method.

13. The medium of any of clauses 1-12, wherein the one or more unique patterns of the pattern layout comprise geometrically unique patterns of the pattern layout.

14. The medium of any of clauses 1-13, wherein the operations further comprise: receiving an original representation of the pattern layout; and determining the set of representative portions of the pattern layout such that the individual representative portions comprise different combinations of the one or more unique patterns of the pattern layout, and at least one of the unique patterns is included in more than one representative portion.

15. The medium of any of clauses 1-14, wherein the selecting is based on a polygon representation of the pattern layout.

16. The medium of any of clauses 1-15, wherein the selecting is based on image or contour representations of patterns in the pattern layout.

17. The medium of clause 16, wherein the image or contour representations of patterns in the pattern layout comprise aerial images and/or mask images.

18. The medium of clause 16 or 17, wherein the image or contour representations of patterns in the pattern layout result from simulation, inspection, or metrology.

19. The medium of any of clauses 1-18, wherein the operations further comprise grouping patterns that repeat across the pattern layout to determine the unique patterns, and determining the set of the representative portions based on grouped patterns.

20. The medium of any of clauses 1-19, wherein the operations further comprise providing the subset of representative portions as training data for training a machine learning model.

21. The medium of clause 20, wherein the machine learning model is associated with optical proximity correction (OPC) and/or source mask optimization (SMO) for a semiconductor lithography process.

22. The medium of any of clauses 1-21, wherein selecting the subset of the representative portions is performed by a discrete optimizer, and the subset of the representative portions is optimized to include a maximum amount of unique geometry from the pattern layout.

23. The medium of clause 22, wherein the discrete optimizer comprises an integer linear programming solver.

24. The medium of any of clauses 1-23, wherein the subset of the representative portions is configured to include an optimally diverse group of unique patterns in a predetermined number of representative portions that form the selected subset of representative portions, wherein the subset of the representative portions are ranked based on the one or more unique patterns they include, and wherein the subset of the representative portions is determined based on rank.

25. The medium of clause 24, wherein the subset of the representative portions are ranked based on a quantity and/or a rarity of the one or more unique patterns each representative portion includes.

26. The medium of clause 24 or 25, wherein the predetermined number of representative portions is set by a user.

27. The medium of any of clauses 1-26, wherein a representative portion of the pattern layout comprises a clip.

28. The medium of any of clauses 1-27, wherein the pattern layout comprises a design layout for a semiconductor wafer.

29. The medium of any of clauses 1-28, wherein a number of the representative portions in the subset of the representative portions is less than a number of representative portions in the set of representative portions by a factor in the range of 10-1000.

30. The medium of clause 29, wherein a number of the representative portions in the subset of the representative portions is less than a number of representative portions in the set of representative portions by a factor in the range of 10-100.

31. A method for selecting a subset of representative portions of a pattern layout, the method comprising:
receiving a set of representative portions of the pattern layout, wherein individual representative portions comprise one or more unique patterns of the pattern layout; and
selecting the subset of the representative portions from the set of representative portions according to a prescribed criterion for unique patterns included in the subset of representative portions in combination.

32. The method of clause 31, wherein the subset of the representative portions is selected such that the representative portions in the subset meet a first criterion, and unique patterns encompassed in the subset also meet a second criterion.

33. The method of clause 32, wherein the first criterion corresponds to a prescribed number of representative portions in the subset, and wherein the second criterion corresponds to including at least a threshold number of unique patterns in the prescribed number of representative portions in combination.

34. The method of any of clauses 31-33, wherein selecting the subset of the representative portions comprises using a set cover solver algorithm.

35. The method of clause 34, wherein the unique patterns in the set of representative portions of the pattern layout are configured as elements in a universe in the set cover solver algorithm.

36. The method of any of clauses 31-35, wherein the prescribed criterion comprises inclusion of at least a threshold number of unique patterns from the set of representative portions of the pattern layout in the selected subset of the representative portions.

37. The method of any of clauses 31-36, wherein the prescribed criterion is set such that the unique patterns included in the selected subset of representative portions in combination represent an entirety of the pattern layout or a portion of the pattern layout.

38. The method of any of clauses 31-37, wherein the prescribed criterion comprises inclusion of an optimally diverse group of unique patterns in a predetermined number of representative portions that form the selected subset of representative portions.

39. The method of clause 38, wherein the optimally diverse group of unique patterns comprises a plurality of unique patterns having geometries that, in combination, represent at least a threshold amount of the pattern layout, given the predetermined number of representative portions that form the selected subset.

40. The method of any of clauses 31-39, wherein a unique pattern of the pattern layout comprises a pattern that is different than other patterns in a spatial window of interest in the pattern layout.

41. The method of clause 40, wherein the unique pattern represents a group of identical or similar patterns across the pattern layout.

42. The method of any of clauses 31-41, wherein the method further comprises identifying unique patterns of the pattern layout by using exact matching, fuzzy matching, or a clustering method.

43. The method of any of clauses 31-42, wherein the one or more unique patterns of the pattern layout comprise geometrically unique patterns of the pattern layout.

44. The method of any of clauses 31-43, further comprising: receiving an original representation of the pattern layout; and determining the set of representative portions of the pattern layout such that the individual representative portions comprise different combinations of the one or more unique patterns of the pattern layout, and at least one of the unique patterns is included in more than one representative portion.

45. The method of any of clauses 31-44, wherein the selecting is based on a polygon representation of the pattern layout.

46. The method of any of clauses 31-45, wherein the selecting is based on image or contour representations of patterns in the pattern layout.

47. The method of clause 46, wherein the image or contour representations of patterns in the pattern layout comprise aerial images and/or mask images.

48. The method of clause 46 or 47, wherein the image or contour representations of patterns in the pattern layout result from simulation, inspection, or metrology.

49. The method of any of clauses 31-48, further comprising grouping patterns that repeat across the pattern layout to determine the unique patterns, and determining the set of the representative portions based on grouped patterns.

50. The method of any of clauses 31-49, further comprising providing the subset of representative portions as training data for training a machine learning model.

51. The method of clause 50, wherein the machine learning model is associated with optical proximity correction (OPC) and/or source mask optimization (SMO) for a semiconductor lithography process.

52. The method of any of clauses 31-51, wherein selecting the subset of the representative portions is performed by a discrete optimizer, and the subset of the representative portions is optimized to include a maximum amount of unique geometry from the pattern layout.

53. The method of clause 52, wherein the discrete optimizer comprises an integer linear programming solver.

54. The method of any of clauses 31-53, wherein the subset of the representative portions is configured to include an optimally diverse group of unique patterns in a predetermined number of representative portions that form the selected subset of representative portions, wherein the subset of the representative portions are ranked based on the one or more unique patterns they include, and wherein the subset of the representative portions is determined based on rank.

55. The method of clause 54, wherein the subset of the representative portions are ranked based on a quantity and/or a rarity of the one or more unique patterns each representative portion includes.

56. The method of clause 54 or 55, wherein the predetermined number of representative portions is set by a user.

57. The method of any of clauses 31-56, wherein a representative portion of the pattern layout comprises a clip.

58. The method of any of clauses 31-57, wherein the pattern layout comprises a design layout for a semiconductor wafer.

59. The method of any of clauses 31-58, wherein a number of the representative portions in the subset of the representative portions is less than a number of representative portions in the set of representative portions by a factor in the range of 10-1000.

60. The method of clause 59, wherein a number of the representative portions in the subset of the representative portions is less than a number of representative portions in the set of representative portions by a factor in the range of 10-100.

61. A system for determining a subset of representative portions of a pattern layout, the system comprising one or more hardware processors configured by machine readable instructions to:
receive a set of representative portions of the pattern layout, wherein individual representative portions comprise one or more unique patterns of the pattern layout; and
select the subset of the representative portions from the set of representative portions according to a prescribed criterion for unique patterns included in the subset of representative portions in combination.

62. The system of clause 61, wherein the subset of the representative portions is selected such that the representative portions in the subset meet a first criterion, and unique patterns encompassed in the subset also meet a second criterion.

63. The system of clause 62, wherein the first criterion corresponds to a prescribed number of representative portions in the subset, and wherein the second criterion corresponds to including at least a threshold number of unique patterns in the prescribed number of representative portions in combination.

64. The system of any of clauses 61-63, wherein selecting the subset of the representative portions comprises using a set cover solver algorithm.

65. The system of clause 64, wherein the unique patterns in the set of representative portions of the pattern layout are configured as elements in a universe in the set cover solver algorithm.

66. The system of any of clauses 61-65, wherein the prescribed criterion comprises inclusion of at least a threshold number of unique patterns from the set of representative portions of the pattern layout in the selected subset of the representative portions.

67. The system of any of clauses 61-66, wherein the prescribed criterion is set such that the unique patterns included in the selected subset of representative portions in combination represent an entirety of the pattern layout or a portion of the pattern layout.

68. The system of any of clauses 61-67, wherein the prescribed criterion comprises inclusion of an optimally diverse group of unique patterns in a predetermined number of representative portions that form the selected subset of representative portions.

69. The system of clause 68, wherein the optimally diverse group of unique patterns comprises a plurality of unique patterns having geometries that, in combination, represent at least a threshold amount of the pattern layout, given the predetermined number of representative portions that form the selected subset.

70. The system of any of clauses 61-69, wherein a unique pattern of the pattern layout comprises a pattern that is different than other patterns in a spatial window of interest in the pattern layout.

71. The system of clause 70, wherein the unique pattern represents a group of identical or similar patterns across the pattern layout.

72. The system of any of clauses 61-71, wherein the one or more hardware processors are further configured to identify unique patterns of the pattern layout by using exact matching, fuzzy matching, or a clustering method.

73. The system of any of clauses 61-72, wherein the one or more unique patterns of the pattern layout comprise geometrically unique patterns of the pattern layout.

74. The system of any of clauses 61-73, wherein the one or more hardware processors are further configured to:
receive an original representation of the pattern layout; and
determine the set of representative portions of the pattern layout such that the individual representative portions comprise different combinations of the one or more unique patterns of the pattern layout, and at least one of the unique patterns is included in more than one representative portion.

75. The system of any of clauses 61-74, wherein the selecting is based on a polygon representation of the pattern layout.

76. The system of any of clauses 61-75, wherein the selecting is based on image or contour representations of patterns in the pattern layout.

77. The system of clause 76, wherein the image or contour representations of patterns in the pattern layout comprise aerial images and/or mask images.

78. The system of clause 76 or 77, wherein the image or contour representations of patterns in the pattern layout result from simulation, inspection, or metrology.

79. The system of any of clauses 61-78, wherein the one or more hardware processors are further configured to group patterns that repeat across the pattern layout to determine the unique patterns, and determining the set of the representative portions based on grouped patterns.

80. The system of any of clauses 61-79, wherein the one or more hardware processors are further configured to provide the subset of representative portions as training data for training a machine learning model.

81. The system of clause 80, wherein the machine learning model is associated with optical proximity correction (OPC) and/or source mask optimization (SMO) for a semiconductor lithography process.

82. The system of any of clauses 61-81, wherein selecting the subset of the representative portions is performed by a discrete optimizer formed by the one or more hardware processors, and the subset of the representative portions is optimized to include a maximum amount of unique geometry from the pattern layout.

83. The system of clause 82, wherein the discrete optimizer comprises an integer linear programming solver.

84. The system of any of clauses 61-83, wherein the subset of the representative portions is configured to include an optimally diverse group of unique patterns in a predetermined number of representative portions that form the selected subset of representative portions, wherein the subset of the representative portions are ranked based on the one or more unique patterns they include, and wherein the subset of the representative portions is determined based on rank.

85. The system of clause 84, wherein the subset of the representative portions are ranked based on a quantity and/or a rarity of the one or more unique patterns each representative portion includes.

86. The system of clause 84 or 85, wherein the predetermined number of representative portions is set by a user.

87. The system of any of clauses 61-86, wherein a representative portion of the pattern layout comprises a clip.

88. The system of any of clauses 61-87, wherein the pattern layout comprises a design layout for a semiconductor wafer.

89. The system of any of clauses 61-88, wherein a number of the representative portions in the subset of the representative portions is less than a number of representative portions in the set of representative portions by a factor in the range of 10-1000.

90. The system of clause 89, wherein a number of the representative portions in the subset of the representative portions is less than a number of representative portions in the set of representative portions by a factor in the range of 10-100.

91. A method for selecting an optimized, geometrically diverse set of clips for a design layout for a semiconductor wafer, the method comprising:
receiving a complete representation of the design layout;
determining a set of representative clips of the design layout such that individual representative clips comprise different combinations of one or more geometrically unique patterns of the design layout, and at least one of the geometrically unique patterns is included in more than one representative clip;
wherein determining the set of representative clips comprises grouping the one or more geometrically unique patterns into groups of similar patterns;
selecting a subset of the representative clips based on the one or more geometrically unique patterns, the subset of the representative clips configured to include:
   (1) each geometrically unique pattern in a minimum number of representative clips; or
   (2) as many geometrically unique patterns of the design layout as possible in a maximum number of representative clips; and
providing the subset of representative portions as training data for training a machine learning model, wherein the machine learning model is associated with optical proximity correction (OPC) and/or source mask optimization (SMO) for a semiconductor lithography process.

92. The method of clause 91, wherein the complete representation of the pattern comprises a Graphic Design system (.GDS) file.

93. The method of any of clauses 91-92, wherein selecting the subset of the representative portions is performed by a discrete optimizer comprising an integer linear programming solver, and the subset of the representative portions is optimized to include a maximum amount of unique geometry from the pattern.

94. The method of any of clauses 91-93, wherein the subset of the representative portions is configured to include as many geometrically unique patterns of the pattern as possible in the maximum number of representative portions, wherein the subset of the representative portions are ranked based on a quantity and/or a rarity of the one or more geometrically unique patterns each representative portion includes, and wherein the subset of the representative portions is determined based on rank.

95. The method of any of clauses 91-94, wherein a number of the representative portions in the subset of the representative portions is less than a number of representative portions in the set of representative portions by a factor of 10 to 1000.

While the concepts disclosed herein may be used for manufacturing with a substrate such as a silicon wafer, it shall be understood that the disclosed concepts may be used with any type of manufacturing system (e.g., those used for manufacturing on substrates other than silicon wafers).

In addition, the combination and sub-combinations of disclosed elements may comprise separate embodiments. For example, one or more of the operations described above may be included in separate embodiments, or they may be included together in the same embodiment.

The descriptions above are intended to be illustrative, not limiting. Thus, it will be apparent to one skilled in the art that modifications may be made as described without departing from the scope of the claims set out below.

1. A non-transitory computer readable medium having instructions thereon or therein, the instructions, when executed by a computer system, configured to cause the computer system to at least:
receive a set of representative portions of a pattern layout, wherein individual representative portions comprise one or more unique patterns of the pattern layout; and
select a subset of the representative portions from the set of representative portions according to a prescribed criterion for unique patterns included in the subset of representative portions in combination.

2. The medium of claim 1, wherein the subset of the representative portions is selected such that a number of the representative portions in the subset meet a first criterion, and a number of unique patterns encompassed in the subset meet a second criterion.

3. The medium of claim 2, wherein the first criterion corresponds to a prescribed number of representative portions in the subset, and wherein the second criterion corresponds to including at least a threshold number of unique patterns in the prescribed number of representative portions in combination.

4. The medium of claim 1, wherein the instructions configured to cause the computer system to select the subset of the representative portions are further configured to cause the computer system to use set cover solver algorithm, and wherein the unique patterns in the set of representative portions of the pattern layout are configured as elements in a universe defined in the set cover solver algorithm.

5. The medium of claim 1, wherein the prescribed criterion comprises inclusion of at least a threshold number of unique patterns from the set of representative portions of the pattern layout in the selected subset of the representative portions.

6. The medium of claim 1, wherein the prescribed criterion is set such that the unique patterns included in the selected subset of representative portions in combination represent an entirety of the pattern layout or a portion of the pattern layout.

7. The medium of claim 1, wherein the prescribed criterion comprises inclusion of an optimally diverse group of unique patterns in a predetermined number of representative portions that form the selected subset of representative portions.

8. The medium of claim 7, wherein the optimally diverse group of unique patterns comprises a plurality of unique patterns having geometries that, in combination, represent at least a threshold amount of the pattern layout, given the predetermined number of representative portions that form the selected subset.

9. The medium of claim 1, wherein each unique pattern represents a group of identical or similar patterns across the pattern layout.

10. The medium of claim 1, wherein the instructions are further configured to cause the computer system to:
receive an original representation of the pattern layout; and
determine the set of representative portions of the pattern layout such that the individual representative portions comprise different combinations of the one or more unique patterns of the pattern layout, and at least one of the unique patterns is included in more than one representative portion.

11. The medium of claim 1, wherein the instructions configured to cause the computer system to select the subset of the representative portions are further configured to cause the computer system to select the subset of the representative portions based on a polygon representation of the pattern layout, or based on image or contour representations of patterns in the pattern layout.

12. (canceled)

13. The medium of claim 12, wherein the instructions configured to cause the computer system to select the subset of the representative portions are further configured to cause the computer system to select the subset of the representative portions based on image or contour representations of patterns in the pattern layout and wherein the image or contour representations of patterns in the pattern layout comprise aerial images and/or mask images that result from simulation, inspection, or metrology.

14. The medium of claim 1, wherein the instructions are further configured to cause the computer system to group patterns that repeat across the pattern layout to determine the unique patterns, and determining the set of the representative portions based on grouped patterns.

15. The medium of claim 1, wherein the instructions are further configured to cause the computer system to provide the subset of representative portions as training data for training a machine learning model.

16. The medium of claim 15, wherein the machine learning model is associated with optical proximity correction (OPC) and/or source mask optimization (SMO) for a semiconductor lithography process.

17. The medium of claim 1, wherein the instructions configured to cause the computer system to select the subset of the representative portions are further configured to cause the computer system to select the subset of the representative portions using by a discrete optimizer, and the subset of the representative portions is optimized to include a maximum amount of unique geometry from the pattern layout, and wherein the discrete optimizer comprises an integer linear programming solver.

18. The medium of claim 1, wherein the subset of the representative portions is configured to include an optimally diverse group of unique patterns in a predetermined number of representative portions that form the selected subset of representative portions, wherein the subset of the representative portions are ranked based on the one or more unique patterns they include, and wherein the subset of the representative portions is determined based on rank, and wherein the subset of the representative portions are ranked based on a quantity and/or a rarity of the one or more unique patterns each representative portion includes.

19. A method comprising:
receiving a set of representative portions of a pattern layout to form a pattern on a substrate in semiconductor manufacturing, wherein individual representative portions comprise one or more unique patterns of the pattern layout; and
selecting, by a hardware computer, a subset of the representative portions from the set of representative portions according to a prescribed criterion for unique patterns included in the subset of representative portions in combination.

20. The method of claim 19, further comprising training a machine learning model using the subset of representative portions as training data.

21. A method comprising:
receiving a complete representation of a design layout for forming a pattern on a semiconductor wafer;
determining a set of representative clips of the design layout such that individual representative clips comprise different combinations of one or more geometrically unique patterns of the design layout, and at least one of the geometrically unique patterns is included in more than one representative clip, wherein determining the set of representative clips comprises grouping the one or more geometrically unique patterns into groups of similar patterns;
selecting a subset of the representative clips based on the one or more geometrically unique patterns, the subset of the representative clips configured to include:
each geometrically unique pattern in a minimum number of representative clips; or
as many geometrically unique patterns of the design layout as possible in a maximum number of representative clips; and
providing the subset of representative portions as training data for training a machine learning model.
